(19) United States
(12) Patent Application Publication
(10) Pub. No.: US 2026/0300549 A1
(43) Pub. Date: Oct. 1, 2026

(54) CLOUD DATA SECURITY FRAMEWORK

(71) Applicant: Wells Fargo Bank, N.A., San Francisco, CA (US)

(72) Inventors: Radhakrishna Venkata Kollipara, Phoenix, AZ (US); Paul Cao, New Rochelle, NY (US); Tata S. Rao, Matthews, NC (US); Fati Sanii, Charlotte, NC (US)

(21) Appl. No.: 19/703,612

(22) Filed: Jun. 10, 2026

Related U.S. Application Data
(63) Continuation of application No. 18/952,304, filed on Nov. 19, 2024.
(60) Provisional application No. 63/604,560, filed on Nov. 30, 2023.

(51) Int. Cl. G06F 21/62; G06F 21/60

(52) U.S. Cl. CPC G06F 21/6254; G06F 21/602; G06F 21/606

(57) ABSTRACT

A computer system and method for migrating on-premise data sources to a cloud platform. The method comprises identifying a source of record from which data is extracted, transformed, and loaded into a load-ready format. Load-ready data is then stored in a network-attached storage with encryption for secure access. Upon detecting the load-ready data via a file polling sensor, a registration directed acyclic graph (DAG) is initiated to register and validate the data within an operational database. A scanning DAG inspects the data for sensitive information, such as personally identifiable information (PII). If sensitive information is detected, a classification DAG identifies specific data elements, and a de-identification DAG encrypts or masks these elements. The de-identified data is then stored in secure cloud storage, where access is enabled within the cloud platform. A monitoring portal provides real-time status updates for the directed acyclic graphs, enhancing oversight of data security processes during migration.

### BACKGROUND

In recent years, substantial datasets have increasingly migrated from on-premises storage solutions to cloud-based platforms. These cloud systems, which offer scalability and significant computational resources, are often well-suited to performing complex analytical processes. Traditionally, data was stored within on-premises facilities, distributed across multiple servers and storage devices. With advancements in cloud technology, a trend toward centralized data storage on cloud platforms has emerged, enabling enhanced processing and analysis of aggregated data.

Nonetheless, this migration introduces certain challenges, particularly concerning the management of sensitive data types, such as Personally Identifiable Information (PII) and financial records. While existing solutions, including encryption and multi-factor authentication, provide layers of data security, they primarily address security concerns reactively, often mitigating risks only after an issue has occurred. The volume and speed of real-time data transfers involved in cloud migrations underscore the need for a comprehensive and adaptable security approach.

### SUMMARY

The present concept relates to securely migrating on-premises data sources to a cloud platform. In one aspect, the concept incorporates a cloud data security framework, wherein upon detection of a load-ready control file by a polling sensor, a registration Directed Acyclic Graph (DAG) is activated. The registration DAG registers the incoming data, identifies its schema, and extracts pertinent columns. Thereafter, a scanning DAG is launched, tasked with identifying PII or other sensitive data within the extracted columns. In another aspect, upon detection of PII or sensitive data, a classification DAG is launched, which scrutinizes the data for Personal Account Number (PAN) details, activates a de-identification DAG for PAN encryption, and inspects for suspicious or unconventional reporting elements.

Embodiments also encompass a computer system structured for secure migration, equipped with processors and non-transitory computer-readable storage media. When executed, the system triggers the registration DAG, initiates the scanning DAG, and subsequently launches the classification and de-identification DAGs based on data attributes, ultimately channeling the data securely to cloud storage. Additionally, within the cloud data security framework, a monitoring portal tracks and reports the status of these active DAGs.

In yet another aspect, a computer program product is presented. Residing on a non-transitory computer-readable storage medium, the product, when executed, handles various steps from registration to data channeling, ensuring secure migration. This includes managing the registration, scanning, classification, and de-identification DAGs, alongside real-time monitoring and status updates through the monitoring portal.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a cloud data security system for secure migration of on-premises data sources to a cloud platform.

FIG. 2 shows an example data flow diagram for securely migrating on-premise data sources to a cloud platform as performed by the system of FIG. 1, with further details shown in FIGS. 2A-2F.

FIG. 2A shows an enlarged view of a portion of FIG. 2 including processes for identifying the source of record, including determining data origin and associating attributes with records.

FIG. 2B shows an enlarged view of a portion of FIG. 2 including processes for file journaling and scanning, creating audit entries and scanning data files for key attributes.

FIG. 2C shows an enlarged view of a portion of FIG. 2 including classification processes, analyzing data sensitivity, such as identifying PII or financial records.

FIG. 2D shows an enlarged view of a portion of FIG. 2 including de-identification processes, where sensitive data elements are modified or encrypted during migration.

FIG. 2E shows an enlarged view of a portion of FIG. 2 including re-identification processes, allowing authorized access to previously de-identified data as needed.

FIG. 2F shows an enlarged view of a portion of FIG. 2 including dispatch processes, routing processed data to cloud storage following security checks.

FIG. 3 shows an example server device of the computer system of FIG. 1.

FIG. 4 shows example physical components of a server device of the computer system of FIG. 1.

### DETAILED DESCRIPTION

This disclosure relates to the secure migration of data from on-premises storage solutions to cloud platforms.

As digital infrastructures evolve, there is an increasing trend toward consolidating data within cloud-based environments, largely due to the scalability and computational capacity these platforms provide. To address the challenges associated with potential exposure of sensitive data during migration, this disclosure presents a cloud data security framework that uses a series of directed acyclic graphs (DAGs) for data protection and security.

A DAG is a type of graph structure with nodes connected by edges in a single direction, lacking cycles. This unidirectional flow between nodes ensures a clear progression without any return to the starting node, allowing systematic and efficient data processing. Within the context of data migration, each DAG is configured to execute specific tasks that rely on this structure for orderly data handling.

The cloud data security framework utilizes a series of DAGs to manage data migration securely. In the initial phase, detection of a load-ready control file by a polling sensor initiates a registration DAG. The registration DAG registers the incoming data, identifies its structure, and extracts designated columns.

Following registration, the framework enters a scanning phase, where a scanning DAG examines the extracted columns to identify any Personally Identifiable Information (PII) or other sensitive data.

If the scanning DAG detects PII or sensitive information, the framework proceeds to the classification phase. A classification DAG further analyzes the dataset for elements such as Personal Account Numbers (PANs). Upon detecting PAN data, a de-identification DAG is engaged to encrypt these details, ensuring confidentiality. Additionally, the DAG inspects the dataset for any elements that may indicate unusual activity, which, if found, are directed to a dispatcher for notification. Notifications may include formats such as a Suspicious Activity Report (SAR) or Unusual Activity Report (UAR).

Once these processes are completed, the data is directed to its final destination, a designated cloud storage location, facilitated by a dispatcher DAG to ensure secure and reliable transmission. Supporting these automated steps, the cloud data security framework includes a monitoring portal, which provides continuous oversight of active DAGs within the system. The portal delivers real-time updates, including operational states (e.g., active, idle, or error) and timestamps marking each stage of activity, enabling vigilant monitoring throughout the data migration process to maintain data security standards.

The concept disclosed here is rooted in computer technology, addressing challenges specifically associated with secure data migration within cloud computing environments. The concept is designed to tackle inherent security vulnerabilities and data fragmentation issues that arise during the migration of data to cloud platforms, which are unique to digital storage and cloud environments.

The concept provides a technical solution to a technical problem by employing a series of DAGs to structure and manage data migration tasks. By utilizing these specialized DAGs, the concept performs parallel processing tailored to each phase of migration, managing both the timing and processing requirements in a way that goes beyond basic data handling. This structured approach allows for enhanced data security and migration efficiency, facilitating a more reliable and organized data transfer process.

The concept further emphasizes data specificity by processing data in a manner tailored to the security and organizational demands of cloud migration. The DAGs are designed to perform specific functions only when necessary, optimizing computational efficiency and minimizing redundant activity. This selective activation not only conserves system resources but also supports a structured data handling process that mitigates risks inherent to transferring sensitive information to cloud platforms.

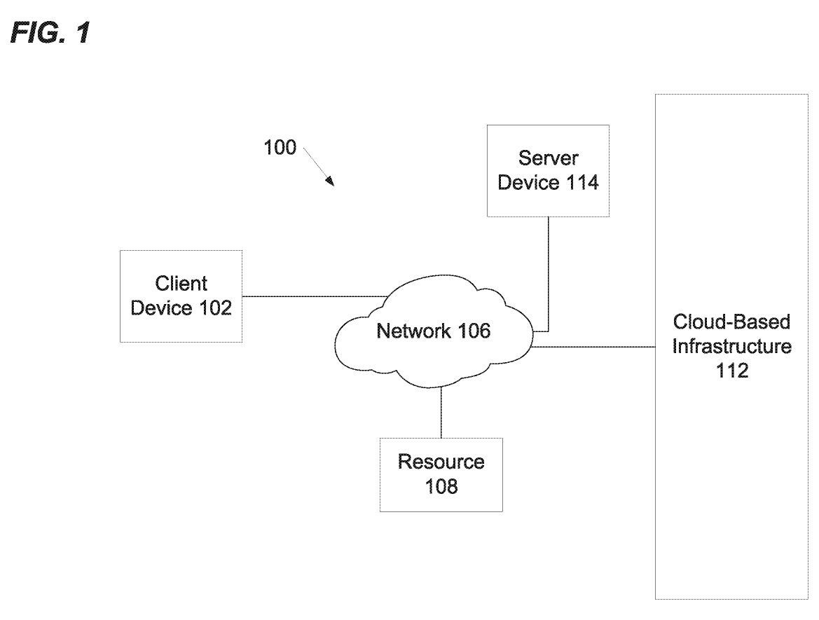

FIG. 1 illustrates a schematic of a computer system 100 designed for the secure migration of on-premises data sources to a cloud platform. Although certain embodiments highlight the transfer of data relevant to financial services—covering data integral to financial entities—the underlying principles of this concept are adaptable, applicable across a wide range of business domains and operational scenarios.

As depicted in FIG. 1, computer system 100 includes a computing environment comprising one or more client devices 102 connected to a cloud-based infrastructure 112 and a server 114 via a network 106. The client device 102, which may be used by business personnel or customers to facilitate transactions, is equipped with at least one processor and memory. In some embodiments, the client device 102 represents an on-premises data source or a device that interfaces directly with components on the network 106.

The cloud-based infrastructure 112 in FIG. 1 represents a server farm or comparable cloud environment, such as Google’s Cloud Platform in some embodiments. The server 114 functions within this framework as part of a cloud data security system, facilitating secure data migration and management. Server 114 coordinates communication between client device 102 and cloud-based infrastructure 112, enabling the transfer, classification, transformation, encryption, storage, retrieval, and decryption of data.

In some embodiments, server 114 executes a method for securely migrating data from on-premises sources (e.g., client device 102) to the cloud-based infrastructure 112. Server 114 initiates a registration DAG, registering incoming data, determining its schema, and extracting relevant columns. Following this, a scanning DAG inspects the extracted columns for Personally Identifiable Information (PII) or other sensitive data. Upon identifying such data, server 114 employs a classification DAG to examine for Personal Account Number (PAN) details, encrypt identified PAN data via a de-identification DAG, and detect any suspicious elements, forwarding alerts to a dispatcher mechanism as needed. Finally, server 114 directs the processed data to specified cloud storage locations using a dispatcher DAG. Within this framework, server 114 also incorporates a monitoring portal to oversee the status of active DAGs and provide status updates for each stage of the process.

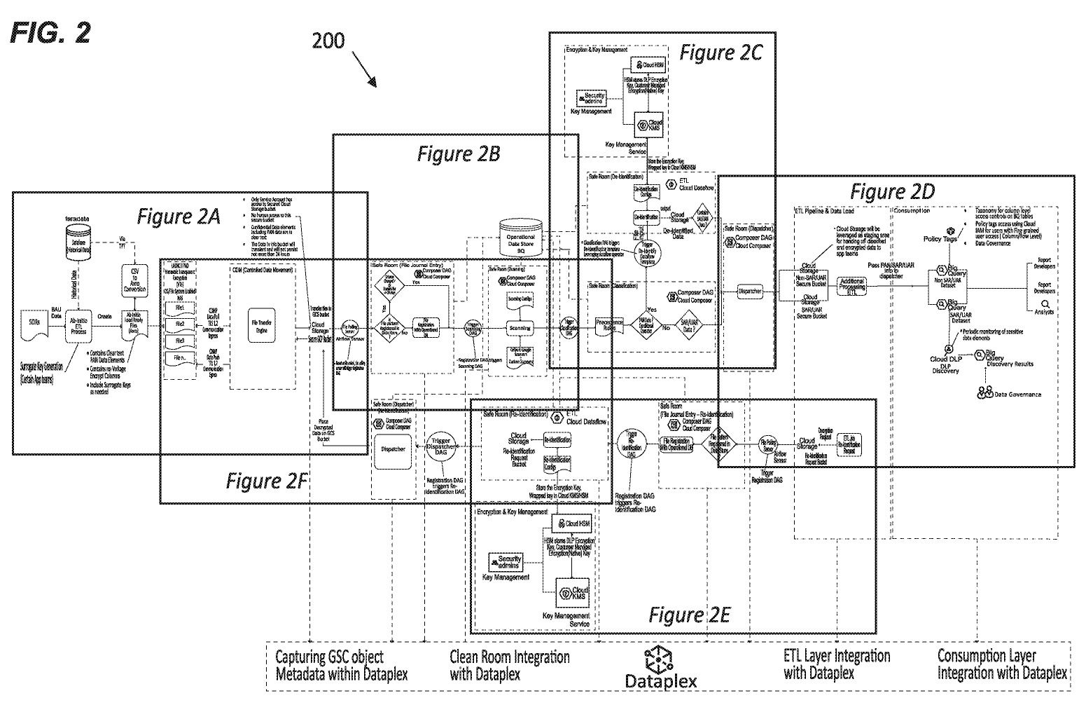

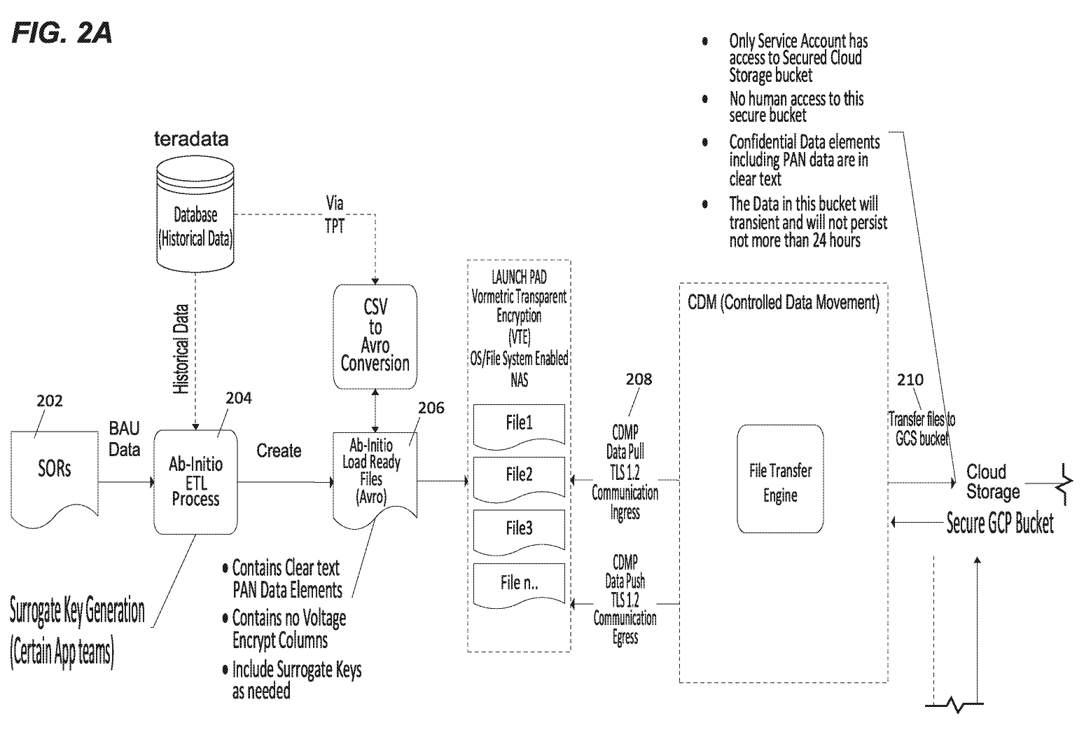

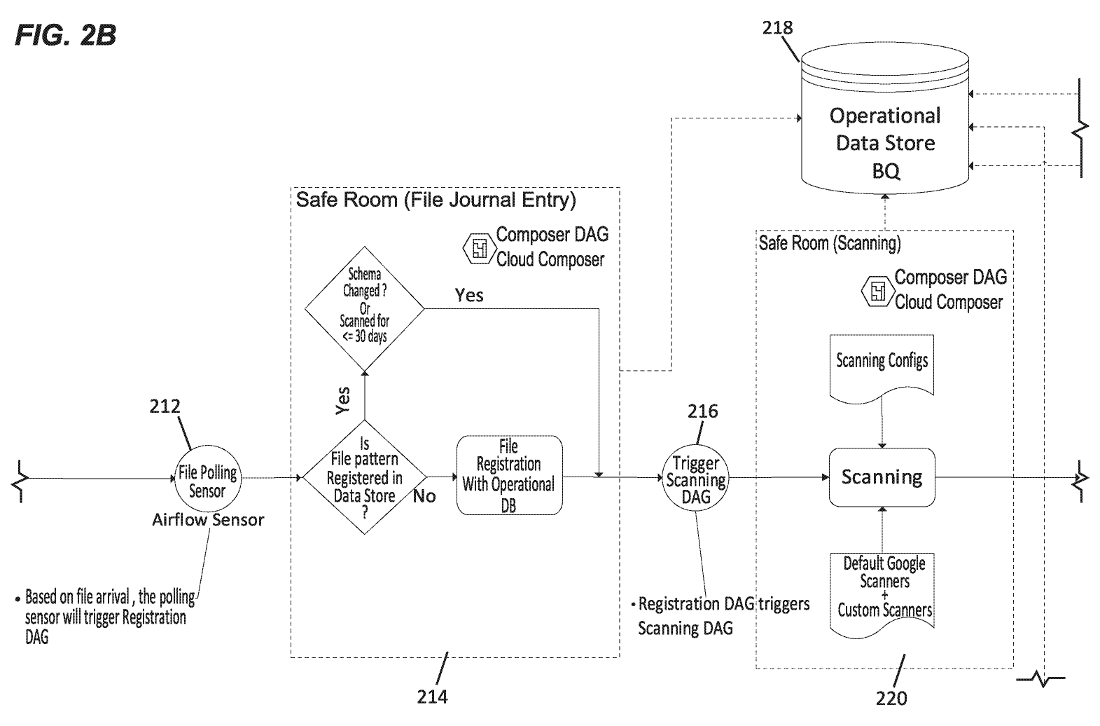

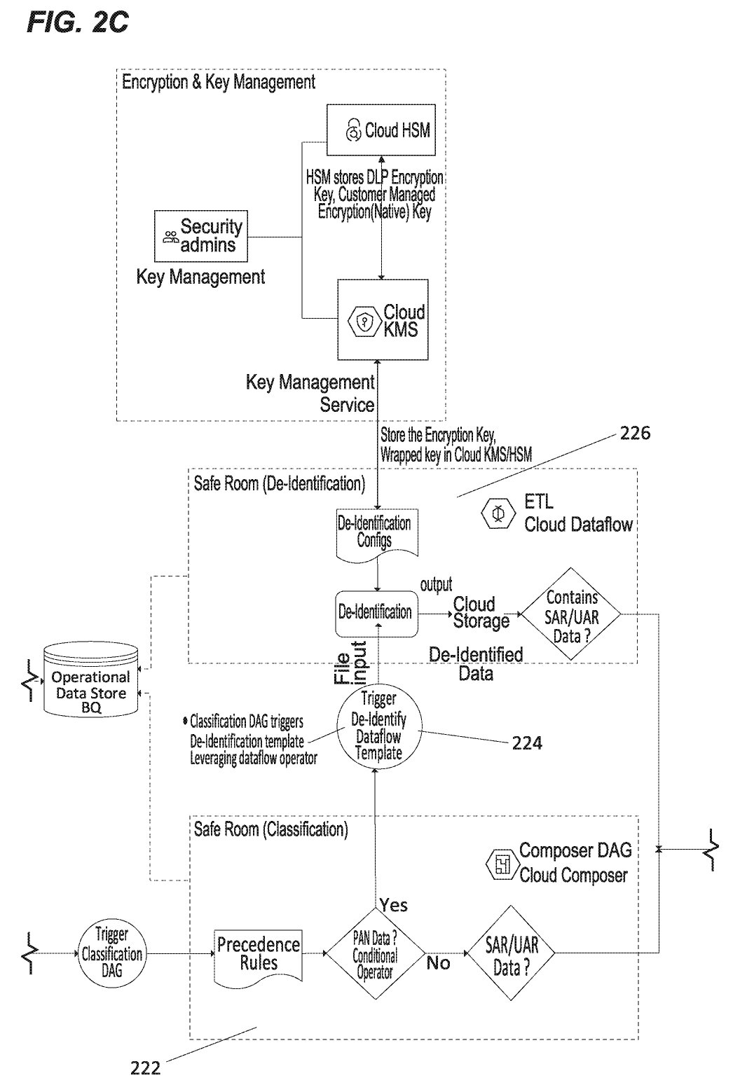

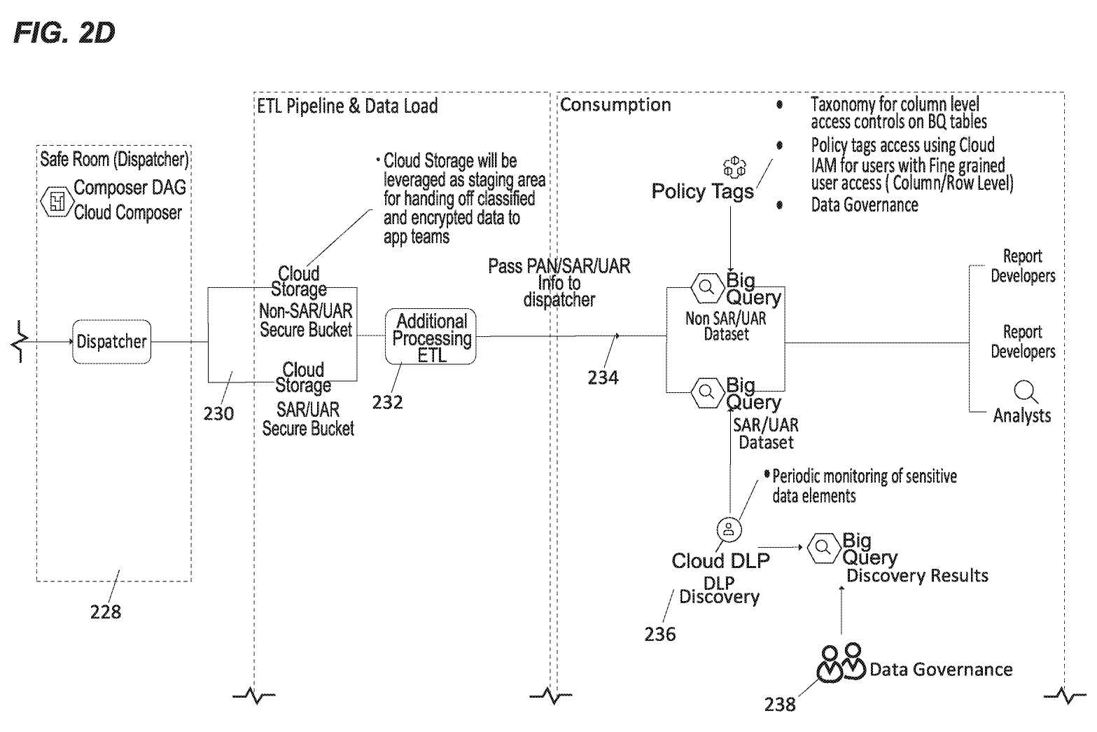

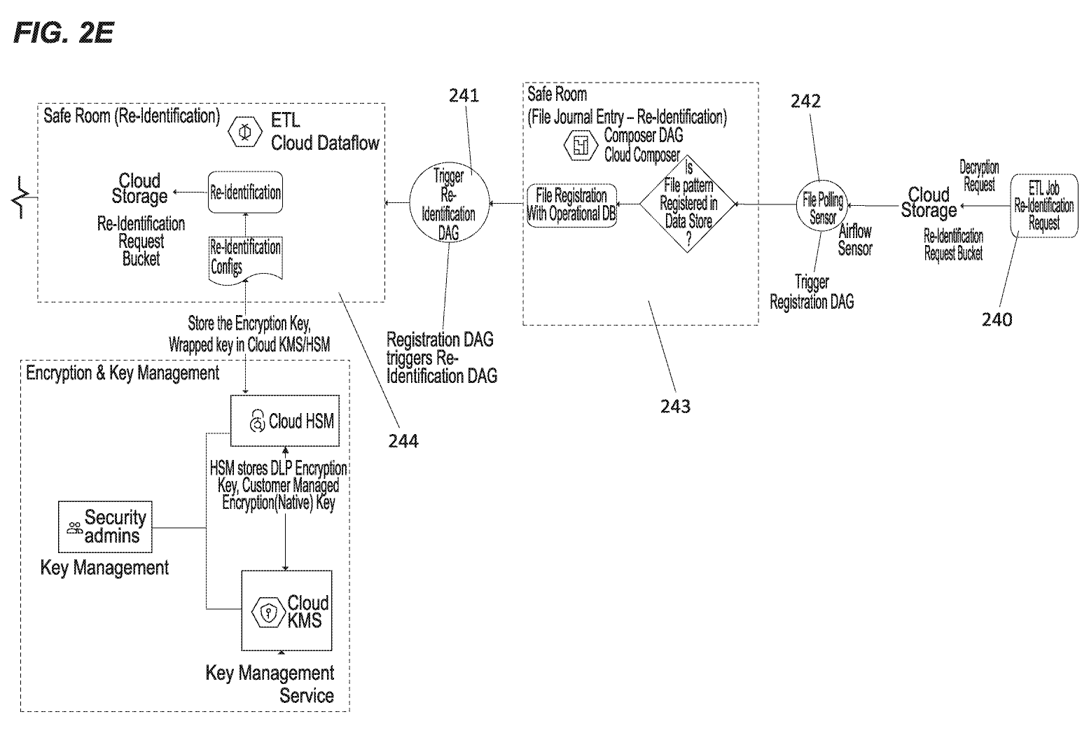

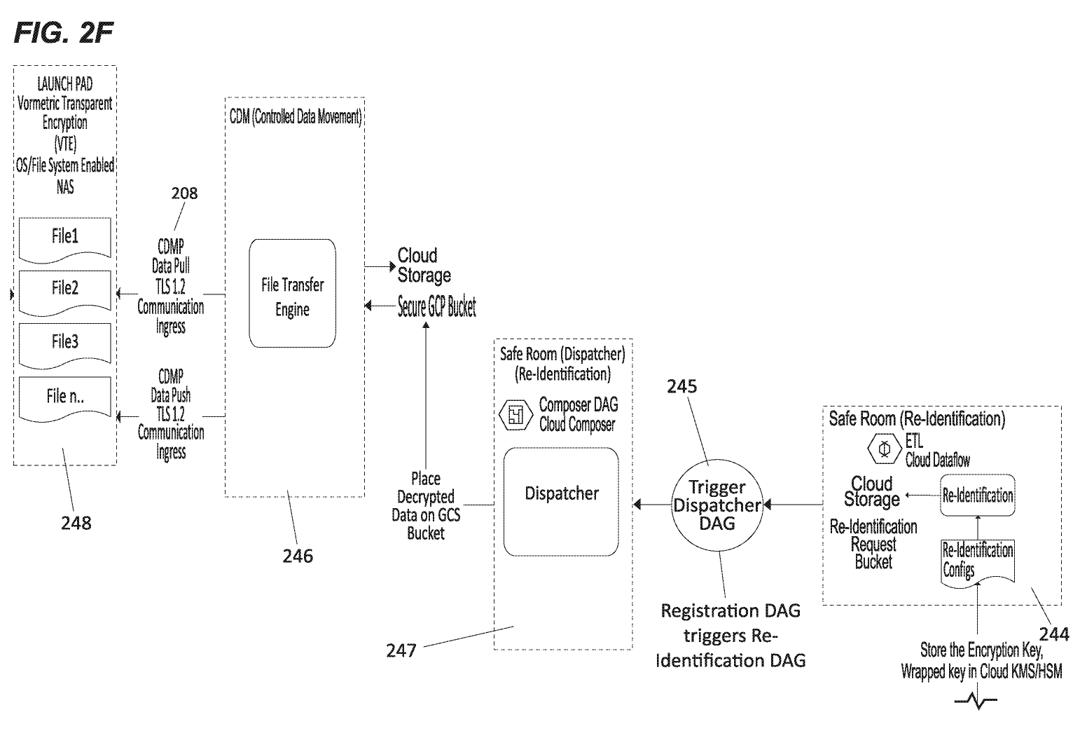

FIG. 2 provides a data flow diagram graphically representing a method 200 of securely migrating on-premise data sources to a cloud platform. Method 200 can be performed by the system illustrated in FIG. 1. Aspects of method 200 are described in connection with FIGS. 2A-F, which show close-up views of portions of the data flow diagram in FIG. 2. The relative positioning of portions of the data flow diagram represented in FIGS. 2A-F, along with a general interconnection of the method steps depicted by the data flow diagram, is shown in FIG. 2.

### Source of Records

Referring to FIG. 2A, in step 202, a Source of Records (SOR) or system of record is identified. An SOR refers to an authoritative data source for a particular piece of information. An SOR is a primary source that holds the most up-to-date, accurate, and trusted version of specific data, to ensure consistent data quality and integrity for that particular dataset.

For instance, an organization might have multiple systems where customer information is stored, such as a transaction record system, an e-commerce platform, and a customer support system. If the transaction record system is designated as the SOR for customer contact information, then any other system that requires this data would ideally fetch or synchronize from the transaction records to ensure they are using the most current and trusted version. Establishing a single SOR minimizes potential conflicts, reduces errors, and ensures consistency in business processes.

Once the SOR is identified, the data, denoted as "Historical Data," commonly held in one or more on-premises data sources (e.g., Teradata, etc.), exemplified as client devices 102, can be retrieved or otherwise loaded for further processing. Teradata is a relational database management system optimized for storing and handling extensive data quantities. Within the ETL context, historical data may denote data archived in the relational database over extended durations, often encompassing past records or historical datasets pertinent to the ETL process for tasks such as analytics, documentation, among others. The historical data can encompass databases, files, Application Programming Interfaces (APIs), or other data-containing systems. Accordingly, step 202 serves as the initial phase of the Extract, Transform, Load (ETL) process.

In step 204, an Ab ETL process is initiated. The term "Ab Initio" refers to a specific software suite widely used in data processing applications for the efficient integration, processing, and transformation of data. The primary objective of an ETL process, such as the one implemented using Ab Initio, is to extract data from one or more source systems, transform the data into a desired format, and subsequently load it into a target database or data warehouse for analysis or further use.

During the ETL process executed by Ab Initio, inputs are received, typically from Source of Records (SORs) or other data repositories. These inputs are processed to create load-ready files, which are files prepared and formatted specifically for subsequent loading into the target system. The preparation often involves data validation, transformation, and possibly the application of business rules or logic.

Additionally, during the aforementioned ETL process, a surrogate key can be generated for the data being processed. A surrogate key is a unique identifier, typically an auto-generated numerical value, used to represent a piece of data or a record in a database. Unlike natural keys, which are derived from the data itself and may have business meaning, surrogate keys have no intrinsic meaning and are used primarily to ensure data integrity and simplify the data indexing and retrieval processes in database systems.

With reference to FIG. 2A, in step 206, the data, once prepared as load-ready, is stored onto a Network Attached Storage (NAS) that is enabled with VTE (Vormetric Transparent Encryption). A NAS represents a dedicated file storage system, accessible through the network, which allows multiple users and heterogeneous client devices to retrieve data from a centralized disk capacity. The VTE is a technology used for the protection of sensitive data. This technology replaces sensitive data with non-sensitive replacement values, known as tokens, ensuring the data's security.

These load-ready files are specifically mounted onto servers termed Launch Pad servers. These servers act as intermediaries or staging areas to facilitate subsequent processes or operations on the data. During this phase, the data may undergo a format conversion, specifically from Comma Separated Values (CSV) to Apache Avro (Avro). CSV is a simple file format used to store tabular data, such as a spreadsheet or database, while Avro is a more compact, binary or JSON-based data serialization framework suitable for a wide array of applications, particularly within the Hadoop ecosystem.

Notably, at this stage of the process, the data contains Personal Account Number (PAN) data elements presented in clear text, meaning the data is unencrypted and can be read without any decryption process. The data, at this juncture, typically lacks encryption.

Additionally, as the process dictates based on specific requirements, surrogate keys may be incorporated. As previously defined, a surrogate key is a unique identifier, generally an auto-generated numerical value, used to represent data in a database system, ensuring data integrity and simplifying indexing and retrieval.

In step 208, the system employs a functionality termed Controlled Data Movement (CDM) to retrieve or pull the previously prepared load-ready files. These files are situated on an on-premises NAS. The term "on-premises" pertains to the deployment of infrastructural components on physical premises, as opposed to a remote or cloud-based environment. NAS represents a specialized file storage mechanism that allows multiple users and various client devices to extract data from a centralized storage system over a network.

The Controlled Data Movement Protocol (CDMP) facilitates this data retrieval process. Notably, during the data transmission phase facilitated by CDMP, the system employs, for example, Transport Layer Security (TLS) 1.2 for communication ingress. TLS represents a cryptographic protocol designed to offer secure communication across computer networks, providing enhanced security measures to ensure data integrity, authentication, and confidentiality during transmission.

With reference to FIG. 2A, in step 210, a Controlled Data Movement (CDM) module is tasked with transferring or placing the previously generated load-ready files onto a specific storage infrastructure referred to as a Cloud Storage Bucket. This operation is performed utilizing a unique identifier, termed a "service id."

The term "Cloud Storage Bucket" pertains to a logical container in cloud-based storage systems, designed to hold data objects or files. These objects can be accessed and managed via this unique identifier, ensuring appropriate data routing and access control. Within these files, certain data elements deemed as confidential remain unencrypted. One such element is the Personal Account Number (PAN) data, presented in a format commonly referred to as clear text or unencrypted form.

Security measures can be instituted for the aforementioned Cloud Storage Bucket. Specifically, access can be limited solely to a designated service account. The term service account relates to an account type that operates without human intervention and is employed specifically for programmatic access to resources, circumventing human users. Explicitly, human access is restricted, ensuring that no individual can directly access or retrieve data from this secured bucket.

Moreover, in certain embodiments, the data housed within this Cloud Storage Bucket possesses a transient characteristic. This denotes that the data, after its placement, may not be persistently stored beyond a predetermined duration, for example, not exceeding a span of 24 hours. This transient nature can serve various purposes, including but not limited to, data security protocols, compliance adherence, or operational requirements.

### File Journal Entry

With additional reference to FIG. 2B, in step 212, a sensing mechanism, hereinafter referred to as the file polling sensor, is deployed to monitor and detect the presence or arrival of designated files, termed "load ready control files." In certain configurations, this file polling sensor may be implemented using an "Airflow sensor." The term "Airflow sensor" pertains to a component within the Apache Airflow platform, a platform primarily utilized for programmatically orchestrating and scheduling complex workflows. This Airflow sensor is designed to continually poll or check for a specific condition or event, in this context, the arrival or presence of the aforementioned load ready control files.

Upon successful detection of these files by the file polling sensor, a subsequent action is initiated: the triggering or generation of a specific Directed Acyclic Graph, referred to as the registration DAG. The concept of a Directed Acyclic Graph refers to a finite, directed graph with no directed cycles. In the realm of data processing and orchestration platforms like Apache Airflow, a DAG can be employed to represent a collection of tasks and their dependencies in a manner that ensures tasks are executed in the correct order and without redundancies.

In step 214, the file registration DAG is invoked to execute a sequence of operations upon the identified load-ready files. The primary operation conducted by this DAG entails registering these incoming files within a designated database. This particular database, referred to as the safe room operational database, is structured to securely store and manage files during the processing pipeline. Additionally, the file registration DAG is responsible for sensing the incoming files, moving them to a Staging Area, and performing checks and validation on these incoming files.

In addition to the primary registration function, the file registration DAG performs a series of supplementary validation and verification tasks. These include the journal entry of incoming load-ready files along with their schema onto the safe room operational database, keeping track of control and summary control files, and tracking and detecting file schema changes. One such task includes checks on the data schema associated with the incoming files. The term "data schema" pertains to the organized structure or blueprint of data, often detailing how data is organized and how relationships between data are handled.

These schema-related checks can encompass multiple sub-tasks, including: (i) determining if the data aligns with any pre-registered file patterns within a predefined data store, thereby verifying the conformity of incoming data to established data structures or templates; and (ii) assessing whether the data has undergone changes or been subjected to scanning procedures within a specific temporal window, in this context, the preceding 30 days. This assessment ensures the timeliness and relevance of the processed data. The file registration DAG ensures the passing of the appropriate schema definition for use by the scanning, classification, and de-identification processes. It extracts the column names and data types from the file schema and stores them in the operational database. The column name and format are key for the de-identification job, preparing a de-identified Avro file accordingly.

Furthermore, the file registration DAG can load on-premises data classification information onto the safe room operational database, enabling the classification engine to use both on-premises and Google classification methods. The system can store and track both inspection and de-identification configuration templates and registers custom Google Scanners, thereby maintaining a comprehensive approach to data processing and security. Through these operations, the file registration DAG not only secures the proper cataloging of incoming files in the Operational Data Store but also validates the integrity, conformity, and timeliness of the data.

### Scanning

With reference to FIG. 2B, in step 216, upon completion of specific prerequisite evaluations, the Directed Acyclic Graph (DAG) designated as the Registration DAG initiates or activates another DAG, termed the Scanning DAG. The triggering mechanism embedded within the Registration DAG is systematic, meaning that the transition to the Scanning DAG is contingent upon the successful validation and approval of data against the specified prerequisite criteria. The specific nature and parameters of these prerequisite checks can be customized based on system requirements or specific data processing objectives.

In step 218, a database, specifically referred to as the Operational Data Store, is utilized to retain and manage status information pertinent to various system subcomponents. This database additionally records the status of each incoming file that is prepared and designated as a load-ready file.

For example, in some embodiments, the Operational Data Store is equipped with a specialized interface termed a "monitoring portal." This portal is tasked with specific functionalities that enhance system monitoring and reporting. Specifically, this portal is designed to: (i) continuously monitor, track, and generate reports related to the operational status of the Directed Acyclic Graphs actively engaged in processing within the system's framework; and (ii) furnish and display real-time or near real-time status updates specifically pertaining to a series of DAGs, including but not limited to the Registration DAG, Scanning DAG, Classification DAG, and De-identification DAG. Thus, the Operational Data Store acts as a centralized repository that provides an overview of ongoing processes and system states. The inclusion of the monitoring portal enables the system to oversee, in a granular manner, the functioning of specific processes, ensuring timely reporting and prompt status visibility to authorized personnel or system administrators.

The scanning process in the Safe Room is designed to inspect and scan data, specifically targeting the identification of PAN, PCI, and PII columns. This can be achieved through the use of built-in or custom Info Types in the Data Loss Prevention (DLP) inspection job, configured to identify sensitive data within a repository, determine its type, and ascertain its location. Such insights are important for effective data protection, enabling the setting of appropriate access controls and permissions. The DLP Inspection Configuration encompasses various aspects, including providing input file details and locations, choosing sampling methods, selecting file types and templates, and determining the actions to be taken. The results of the DLP scan, which include the column names and their corresponding Info Types, are stored in a BigQuery table. Aggregation queries are then executed to further refine the data, linking columns to their specific Info Types. This aggregated scanning output is subsequently updated in the Safe Room Operational Database. Completing this phase triggers the next job in the DLP process, which can involve the classification of data to identify whether it falls under SAR, UAR, or NON-SAR categories, thus streamlining data handling and security processes.

Sensitive Data Protection in the Safe Room can incorporate both built-in InfoType detectors and custom creation options, allowing for a tailored approach to data security. This customization can be useful for defining unique InfoType detectors to inspect data matching specific patterns. The custom scanners developed by Safe Room are adept at identifying specific data types, such as financial account numbers, as well as data related to Suspicious Activity Reports (SAR) and Unusual Activity Reports (UAR). These custom scanners play a crucial role not only in the accurate identification of SAR/UAR and restricted elements but also in ensuring compliance with governance and control standards. Additionally, the use of regular expression (regex) detectors within Sensitive Data Protection enables the system to detect data matches based on specific regex patterns, further enhancing the effectiveness of data protection strategies.

With reference to FIG. 2B, in step 220, upon activation of a Directed Acyclic Graph (DAG) specifically designed for scanning, termed a Scanning DAG, a systematic evaluation is initiated to scrutinize data for specific elements. These elements are generally categorized as Personally Identifiable Information (PII). Within this category, the Scanning DAG specifically searches for the presence of the Personal Account Number (PAN), data associated with SAR, or data corresponding to a UAR.

The term "Personally Identifiable Information" refers to any data that could potentially identify a specific individual. Any information that can be used to distinguish one person from another and to de-anonymize previously anonymous data can be considered PII. The "Personal Account Number" typically represents a unique card or account number assigned to individuals and is commonly used in financial transactions. A "Suspicious Activity Report" is a document that financial institutions often file with the Financial Crimes Enforcement Network when there are suspected cases of money laundering, fraud, or similar activities. An "Unusual Activity Report" is similarly a record or documentation of activities that are deemed out of the ordinary but may not necessarily indicate suspicious or illegal activity.

Upon identifying any of the aforementioned elements within the data, the Scanning DAG subsequently updates the Operational Data Store with the relevant details and findings from the scan. Thus, the Operational Data Store functions as a central repository to collect, consolidate, and manage data from diverse sources in a unified manner, ensuring that the detected elements and corresponding data points are systematically catalogued and made accessible for further processing or analysis.

### Classification

With additional reference to FIG. 2C, in step 222, contingent upon the identification of either PII or other comparable sensitive data elements, a Classification DAG is activated. The Classification DAG initiates an evaluative process to discern the presence of specific elements, notably PAN data and data corresponding to either a SAR or UAR. Following the requisite assessments, this DAG determines the subsequent data routing and directs the data either toward a process known as "de-identification," which aims to mask or remove any data elements that can identify an individual, or toward a "dispatcher," a system or method designated to manage and control the distribution or routing of data to its next processing stage.

In step 224, the Classification DAG engages in an evaluative operation to determine the presence of specific data elements within its purview. When the Classification DAG identifies elements corresponding to PAN, it initiates a subsequent call to another Directed Acyclic Graph (DAG) distinctly purposed for the de-identification of data, hereinafter referred to as the De-identification DAG. The purpose of invoking the De-identification DAG is to apply specific processes or algorithms to render the PAN data non-identifiable or obscured, ensuring that the original data cannot be easily inferred or reverse-engineered, thereby enhancing the security and privacy of the data within the system.

In the classification process, the method involves extracting file columns and their corresponding information types from the operational database. This process integrates both on-premises intelligence Info-types and Google InfoType, which are then input into the Classification Presence Rules. The on-premises intelligence can be sourced through the Google Data Catalog, ensuring comprehensive and accurate data gathering. The system can employ precedence rules, balancing on-premises and Google intelligence, to determine the course of action for incoming files. Particularly, files containing PAN data can be directed to the de-identification engine. In addition to PAN data, the system also checks each file for the presence of SAR/UAR data, ensuring thorough and secure handling of sensitive information.

### De-Identification

In step 226, the De-Identification DAG engages in a process to transform or obscure sensitive data elements, ensuring they are rendered non-identifiable within the context of the dataset. This transformation process seeks to maintain the utility of the data for subsequent analytical or operational tasks while simultaneously ensuring that the original, sensitive content cannot be straightforwardly discerned or reverse engineered. Once the De-Identification DAG completes the data transformation, it then transfers or directs the modified data to a distinct module or function within the system, commonly known as a dispatcher.

De-identification can involve the encryption of Personally Identifiable Information (PII) data, utilizing tools like Google Cloud DLP, Cloud KMS, and Dataflow. This process can begin with loading a cleartext AVRO file provided by the application team. Subsequently, a configuration file, which can include details about the columns to be de-identified and the Cloud KMS key (sourced from the classification phase), can be loaded. The AVRO records can then be converted into a format that is compatible with the DLP API, facilitating the encryption of the data. Once encrypted, this data is written back into an AVRO file and stored securely in a GCS bucket. In embodiments, the de-identification process can offer significant value additions, such as the flexibility to support various types of encryption methods, including Crypto hashing and Deterministic encryption (DE). The de-identification process also allows for the encryption of entire columns in each table or specific rows based on certain conditions, ensuring a versatile and robust approach to data security.

With additional reference to FIG. 2D, in step 228, the dispatcher is designed to interrogate or inspect incoming data files to determine their content characteristics. One of the tasks of the dispatcher in this context is to ascertain the presence of specific data elements or markers, notably the Suspicious Activity Report (SAR) and/or the Unusual Activity Report (UAR).

In step 230, upon examination of the files, the dispatcher allocates or sends the load-ready files to specific storage units, hereinafter referred to as buckets. Depending on the identified data elements, these files are directed to one of two categories of buckets: either the SAR/UAR bucket or the Non SAR/UAR bucket.

In step 232, an Application Team, equipped with specialized access rights and functionalities, is responsible for the retrieval and subsequent processing of specific data files. The term "de-identified files" as used herein denotes data files wherein specific data elements, which could have potentially identified or linked to individual entities or sources, have been masked, encrypted, or otherwise transformed to obscure the original identifying information. The primary intent behind such de-identification processes is to enhance data privacy and reduce the potential risks associated with data misuse or unauthorized access. Upon accessing the two buckets, the Application Team actively retrieves or reads the de-identified files, making them available for further analytical or operational processing, as necessitated by the overarching system objectives.

In step 234, the Application Team is tasked with transferring this de-identified data to structured storage entities, commonly termed "tables." Specifically, these tables reside within a platform known as "BQ" or "BigQuery." BigQuery is an enterprise-grade, fully managed, and highly scalable data warehouse solution, typically used for big data analytics, which facilitates rapid SQL queries. Within the context of this procedure, the Application Team "loads" or transfers the de-identified data into specific BigQuery tables. This loading process involves transferring the data from its source format into a structured table format that is suitable for query-based analytical processing within the BigQuery environment.

In step 236, a systematic and recurring observation procedure is instigated. This procedure targets the data residing within the BigQuery environment. One objective of this periodic surveillance is to identify and potentially mitigate any occurrence of Personally Identifiable Information (PII) elements within the stored data. Personally Identifiable Information, or PII, refers to any data that can be utilized, either singularly or in conjunction with other data, to identify, locate, or contact an individual. Recognizing and managing PII is of paramount importance to uphold data privacy standards and ensure compliance with applicable data protection regulations.

In step 238, a DLP Discovery module, a specialized analytical tool within the operational architecture designed for the detection, classification, and management of sensitive data, undertakes prescribed functions and subsequently produces an outcome. This outcome, hereinafter referred to as "inspection results," embodies the findings of the module's surveillance activities. This step delineates the process wherein the DLP Discovery module's surveillance findings are systematically documented and subsequently availed for the scrutiny of a governance team.

### Re Identification

With additional reference to FIG. 2E, in step 240, the application team initiates a specific procedural request in the realm of Extract, Transform, Load (ETL) processes. This request, termed the re-identification request, seeks to reverse previous data anonymization measures, thereby restoring the original identity-linked attributes to the data in question. Upon formulating this request, the application team selects the pertinent data file. This file, which holds the data entities primed for the re-identification procedure, is then positioned within a specialized data storage structure. A bucket within GCS terminology signifies a user-defined container that holds data objects. In some embodiments, this storage structure may be provided by Google Cloud Storage, a robust, scalable, and fully-managed object storage service rendered by Google Cloud Platform.

In step 242, an automated electronic monitoring mechanism, hereinafter designated as the file polling sensor, embarks upon a systematic scan within a predetermined data storage structure. This file polling sensor, which may be exemplified by an Airflow sensor, has the principal objective of identifying the presence or arrival of specific data files within the storage structure. Upon successfully detecting the designated data files within the bucket, the file polling sensor triggers an automated process series termed the Re-Identification DAG.

In step 243, the Registration DAG manages incoming data by registering the pattern of the incoming file to the operational database. This registration process ensures that the data structure and its details are accurately logged and stored for subsequent processing. Following this, in step 241, the Registration DAG initiates the Re-Identification DAG. This triggering is essential in the data handling process, as the Re-Identification DAG is responsible for decrypting any previously encrypted data. This action allows the data to be restored to its original state, maintaining continuity and usability of the information within the system's workflow.

In step 244, a computational process, the Re-Identification DAG, is implemented with the primary objective of conducting data decryption operations. The term "decryption" refers to the process of converting encoded or ciphered data back into its original, comprehensible format, which was previously transformed into an unreadable format using cryptographic algorithms for security or data protection.

Re-identification is the process of decrypting previously encrypted columns, effectively reversing the de-identification process. This procedure can begin with loading an encrypted AVRO file, supplied by the application team. Alongside this, a configuration file is loaded, containing information about the columns that need to be re-identified and the corresponding Cloud KMS key, which is an input derived from the classification stage. The AVRO records can then be converted into a format compatible with the DLP API, enabling the calling of the DLP API to decrypt the data. Once decrypted, the data is written back into an AVRO file and securely stored in a GCS bucket. Thus, the re-identification process is configured to restore the data to its original, usable form while maintaining data integrity and security throughout its lifecycle

### Dispatch

With additional reference to FIG. 2F, in step 245, the Re-Identification DAG, upon successfully completing the decryption process, initiates the next phase by triggering the Dispatch DAG. Then, in step 247, the Dispatch DAG handles the distribution of the re-identified data to ensure that the data, once returned to its original state, is correctly dispatched for its intended use or further processing. The Dispatch DAG is configured to integrate the re-identification and subsequent distribution processes within the system's operational framework.

In step 246, the re-identified data is systematically positioned into a designated storage solution. In step 248, upon the availability of the re-identified data within the previously mentioned bucket, a specific data transfer mechanism, termed the Controlled Data Movement Process (CDMP), is engaged to facilitate the transfer of this re-identified data. Specifically, the CDMP ensures the movement of data to a predefined computational infrastructure, hereafter referred to as Launch Pad servers. In some embodiments, the data transfer facilitated by the CDMP employs a stringent communication protocol, known as Transport Layer Security version 1.2 (TLS 1.2), which ensures that the data egress, or the outbound movement of data from its source location to its intended destination, occurs under secure and encrypted conditions, thereby safeguarding the integrity and confidentiality of the data in transit.

### Data Catalog Integration

Furthermore, an integration process is initiated that seamlessly amalgamates the operations of the Safe Room with a data management solution. One example of such a data management solution is Dataplex from Google. Dataplex represents a comprehensive solution, typically employed for advanced data management and governance across varied storage systems.

The Safe Room system can be fully integrated with Google Data Catalog, creating a seamless connection for managing sensitive data. The on-premises intelligence, particularly information about which columns contain PII, can be sourced from the Data Catalog. This intelligence is provided by the application team, who are responsible for placing this information into the Data Catalog. Subsequently, the Safe Room system retrieves this intelligence from the Data Catalog and utilizes it in the Classification DAG. Accordingly, the integration can be used in the de-identification of columns, ensuring that PII data is properly encrypted and secured.

Additionally, the application team also inputs intelligence into the Data Catalog for the re-identification process. This ensures that once the data has been securely processed and needs to be returned to its original form, the system has the necessary information to reverse the encryption accurately and efficiently. This dual approach, encompassing both de-identification and re-identification, underscores the comprehensive and robust data protection strategy employed by the Safe Room, leveraging the capabilities of Google Data Catalog for enhanced data security and management.

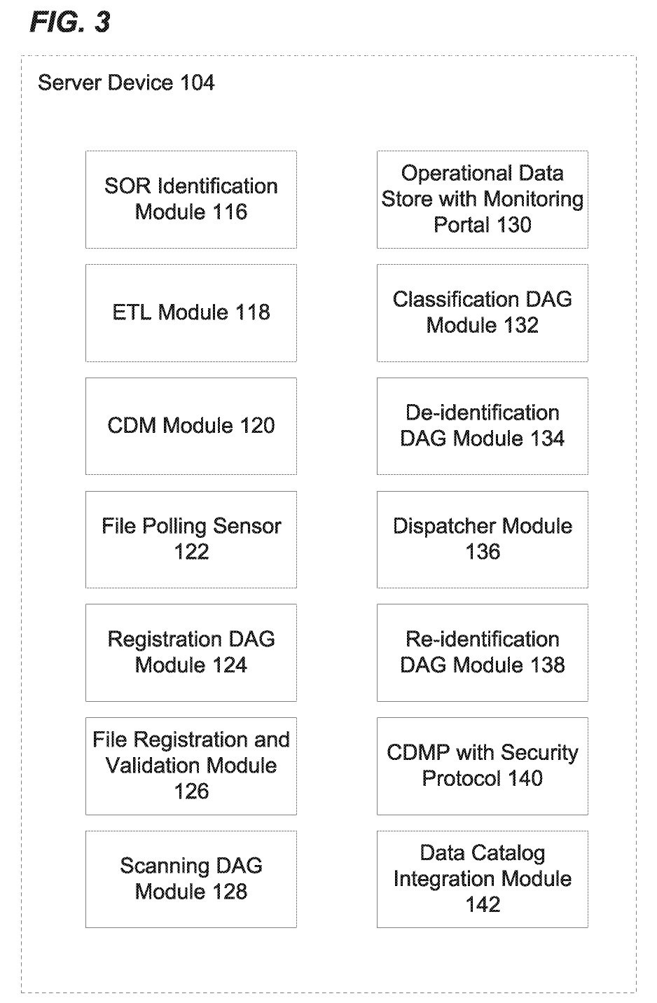

As shown in FIG. 3, server 114 can comprise a plurality of modules, each configured as a specialized component adapted to perform designated computational processing tasks within computer system 100. For example, server 114 can include various modules integrated to execute the specific steps outlined in the method 200 of securely migrating on-premise data sources to a cloud platform described in connection with FIG. 2.

The SOR identification module 116 is configured to identify the authoritative data source, or source of record, for specific data elements, ensuring that data quality and integrity are maintained by designating a single source of truth within the migration process, as described in step 202 in FIG. 2A. The ETL module 118 performs extraction, transformation, and loading operations, pulling data from identified sources of records, converting it to meet specific format requirements, and loading it into the target system for further processing. The ETL module 118 facilitates accurate and efficient data preparation, as required in steps 204-208.

The CDM module 120 is responsible for controlled data movement, securely transferring load-ready files to designated cloud storage while implementing access controls and encryption protocols, as shown in step 210. Additionally, the file polling sensor 122 detects the arrival of designated files, known as load-ready control files, by continuously monitoring specific conditions. The file polling sensor 122, described in step 212, enables the controlled activation of downstream processes, such as directed acyclic graphs (DAGs).

The registration DAG module 124 plays a crucial role in managing incoming files by registering their pattern within an operational database and validating data structures. As outlined in step 214, the registration DAG module 124 performs essential registration and validation tasks, which are further supported by the file registration and validation module 126. The file registration and validation module 126 tracks schema and logs entries to ensure compliance with data integrity standards, thereby enhancing file consistency across the migration workflow.

The scanning DAG module 128 is adapted to inspect incoming data for sensitive information, specifically targeting elements like PAN, PCI, and PII. The scanning DAG module 128 employs custom data loss prevention (DLP) inspection jobs to identify such elements, which aligns with step 216. To manage status information for various subcomponents within the system, the operational data store with monitoring portal 130 retains critical operational data and provides real-time reporting on DAG statuses, offering efficient system management as seen in step 218.

Sensitive data classification is handled by the classification DAG module 132, which flags specific data elements such as PAN, SAR, and UAR. The classification DAG module 132, corresponding to steps 222 and 224, directs these flagged elements to de-identification processes, ensuring that all sensitive data is properly identified and secured within the system.

For further data security, the de-identification DAG module 134 executes encryption and transformation processes on sensitive data before it is stored in cloud storage, using tools such as Google Cloud DLP to prevent unauthorized access. This process is described in step 226. The dispatcher module 136 is responsible for organizing processed files based on their characteristics, allocating them to appropriate storage units as described in step 228, and ensuring regulated storage of sensitive data elements.

The re-identification DAG module 138 decrypts and restores previously encrypted data to its original format as required, effectively reversing de-identification measures. The re-identification DAG module 138 performs this process in step 240 to maintain data usability for authorized retrievals. The CDMP with security protocol 140 ensures the secure transfer of data by employing protocols like TLS 1.2, thereby safeguarding the data's integrity during its movement to designated infrastructures, as specified in step 248.

Finally, the data catalog integration module 142 connects the safe room system with the Google data catalog, allowing accurate retrieval of data classification information necessary for secure de-identification and re-identification processes. The data catalog integration module 142 leverages data catalog intelligence for streamlined, secure data management, as described in steps 245 and 246.

Together, these modules form an integrated subsystem within server 114, facilitating the seamless and secure migration of on-premise data to a cloud platform. Each module performs specific aspects of the migration and data protection workflow, contributing to the secure classification, handling, and storage of sensitive data throughout the system.

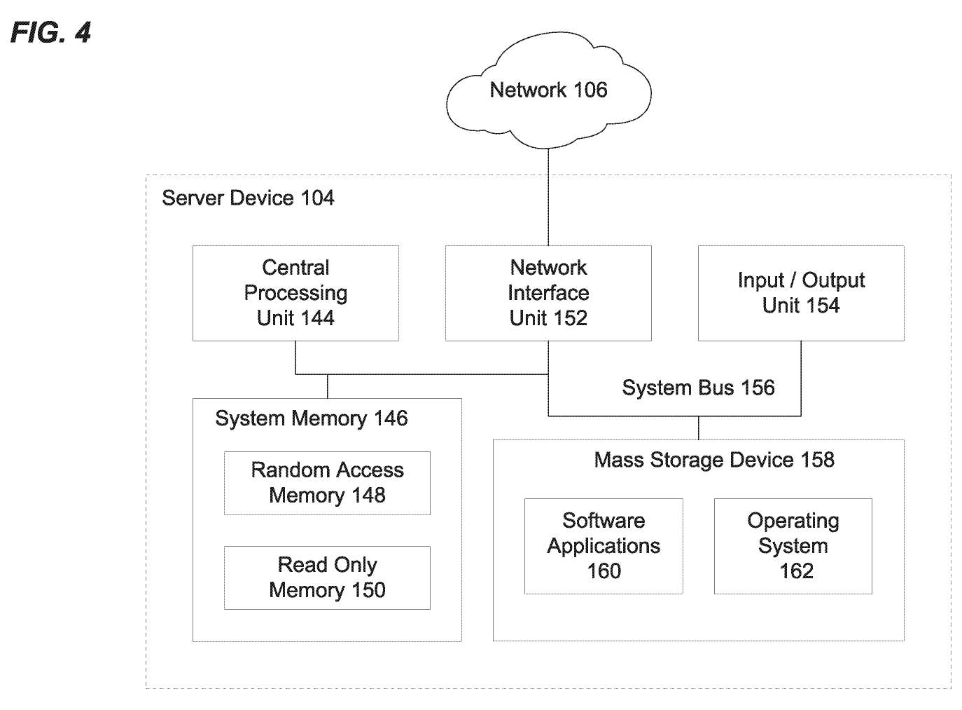

As illustrated in the embodiment of FIG. 4, the example server 114, which can provide the functionality described herein, can include at least one Central Processing Unit (CPU) 144, a system memory 146, and a system bus 156 that couples the system memory 146 to the CPU 144. The system memory 146 includes a Random Access Memory (RAM) 148 and a Read-Only Memory (ROM) 150. A basic input/output system containing the basic routines that help transfer information between elements within the server 114, such as during startup, is stored in the ROM 150. The server 114 further includes a mass storage device 158. The mass storage device 158 can store software instructions and data. A central processing unit, system memory, and mass storage device similar to that shown can also be included in the other computing devices disclosed herein.

The mass storage device 158 is connected to the CPU 144 through a mass storage controller (not shown) connected to the system bus 156. The mass storage device 158 and its associated computer-readable data storage media provide non-volatile, non-transitory storage for the server 114. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, Digital Versatile Discs (DVDs), other optical storage media, magnetic cassettes, magnetic tape, magnetic disk storage or other magnetic storage devices, or any other medium which can be used to store the desired information and which can be accessed by the server 114.

According to various embodiments of the invention, the server 114 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server 114 may connect to network 106 through a network interface unit 152 connected to the system bus 156. It should be appreciated that the network interface unit 152 may also be utilized to connect to other types of networks and remote computing systems. The server 114 also includes an input/output controller 154 for receiving and processing input from a number of other devices, including a touch user interface display screen or another type of input device. Similarly, the input/output controller 154 may provide output to a touch user interface display screen or other output devices.

As mentioned briefly above, the mass storage device 158 and the RAM 148 of the server 114 can store software instructions and data. The software instructions include an operating system 162 suitable for controlling the operation of the server 114. The mass storage device 158 and/or the RAM 148 also store software instructions and applications 160, that when executed by the CPU 144, cause the server 114 to provide the functionality of the server 114 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for securing data during migration to a cloud platform, comprising:
detecting, using a file polling sensor, a presence of data in a storage location;
initiating a registration directed acyclic graph to register the data within an operational database and validate a structure of the data;
activating a scanning directed acyclic graph to inspect the data for sensitive information;
upon detecting the sensitive information, initiating a classification directed acyclic graph to identify specific data elements for de-identification and to determine a routing path for the data based on a classification of the sensitive information;
applying a de-identification directed acyclic graph to transform the specific data elements into de-identified data; and
routing, using a dispatcher directed acyclic graph, the de-identified data to a cloud storage location based on the routing path.

2. The method of claim 1, wherein routing the de-identified data to the cloud storage location comprises routing the de-identified data to a first cloud storage location upon detecting a suspicious activity report element in the de-identified data, and routing the de-identified data to a second cloud storage location upon detecting an absence of the suspicious activity report element.

3. The method of claim 1, further comprising applying a re-identification directed acyclic graph to decrypt the de-identified data to restore the de-identified data to its original form.

4. The method of claim 1, further comprising employing a monitoring portal to display real-time status updates for the registration directed acyclic graph, the scanning directed acyclic graph, the classification directed acyclic graph, the de-identification directed acyclic graph, and the dispatcher directed acyclic graph.

5. The method of claim 1, wherein initiating the registration directed acyclic graph further comprises creating a journal entry for the data and a schema of the data in the operational database.

6. The method of claim 1, wherein initiating the registration directed acyclic graph further comprises detecting a change in a schema of the data.

7. The method of claim 1, further comprising retrieving data classification intelligence from a data catalog, wherein the classification directed acyclic graph uses the data classification intelligence to identify the specific data elements for de-identification.

8. The method of claim 1, wherein the data is stored in the storage location for a predetermined duration prior to being routed to the cloud storage location.

9. The method of claim 1, further comprising periodically scanning the de-identified data in the cloud storage location to detect personally identifiable information.

10. The method of claim 1, further comprising transferring the de-identified data to the cloud storage location using a cryptographic security protocol.

11. A system for securing data during migration to a cloud platform, comprising:
one or more processors; and
a memory storing instructions that, when executed by the one or more processors, cause the system to:
detect, using a file polling sensor, a presence of data in a storage location;
initiate a registration directed acyclic graph to register the data within an operational database and validate a structure of the data;
activate a scanning directed acyclic graph to inspect the data for sensitive information;
upon detecting the sensitive information, initiate a classification directed acyclic graph to identify specific data elements for de-identification and to determine a routing path for the data based on a classification of the sensitive information;
apply a de-identification directed acyclic graph to transform the specific data elements into de-identified data; and
route, using a dispatcher directed acyclic graph, the de-identified data to a cloud storage location based on the routing path.

12. The system of claim 11, wherein routing the de-identified data to the cloud storage location comprises routing the de-identified data to a first cloud storage location upon detecting a suspicious activity report element in the de-identified data, and routing the de-identified data to a second cloud storage location upon detecting an absence of the suspicious activity report element.

13. The system of claim 11, wherein the instructions further cause the system to apply a re-identification directed acyclic graph to decrypt the de-identified data to restore the de-identified data to its original form.

14. The system of claim 11, wherein the instructions further cause the system to employ a monitoring portal to display real-time status updates for the registration directed acyclic graph, the scanning directed acyclic graph, the classification directed acyclic graph, the de-identification directed acyclic graph, and the dispatcher directed acyclic graph.

15. The system of claim 11, wherein initiating the registration directed acyclic graph further causes the system to create a journal entry for the data and a schema of the data in the operational database.

16. The system of claim 11, wherein initiating the registration directed acyclic graph further causes the system to detect a change in a schema of the data.

17. The system of claim 11, wherein the instructions further cause the system to retrieve data classification intelligence from a data catalog, wherein the classification directed acyclic graph uses the data classification intelligence to identify the specific data elements for de-identification.

18. The system of claim 11, wherein the data is stored in the storage location for a predetermined duration prior to being routed to the cloud storage location.

19. The system of claim 11, wherein the instructions further cause the system to periodically scan the de-identified data in the cloud storage location to detect personally identifiable information.

20. The system of claim 11, wherein the instructions further cause the system to transfer the de-identified data to the cloud storage location using a cryptographic security protocol.
